(19) United States
(12) Patent Application Publication
(10) Pub. No.: US 2024/0414662 A1
(43) Pub. Date: Dec. 12, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/808,101

(22) Filed: Aug. 19, 2024

Related U.S. Application Data
(63) Continuation of application No. PCT/CN2023/076685, filed on Feb. 17, 2023.

(30) Foreign Application Priority Data
Feb. 26, 2022 (CN) 202210180223.5

(51) Int. Cl. H04W 52/32; H04W 52/14; H04W 52/24; H04W 52/42

(52) U.S. Cl. CPC H04W 52/325; H04W 52/146; H04W 52/242; H04W 52/42

(57) ABSTRACT

A node first receives a first information set, the first information set is used to indicate a first reference signal resource set and a second reference signal resource set; then transmits a target signal, the target signal comprises a second information set; the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set. This improves the reporting method of power headroom when the terminal is configured with multiple reference signal resource sets to improve spectrum efficiency.

### CROSS REFERENCE TO RELATED APPLICATIONS

The present application is the continuation of the international patent application No. PCT/CN2023/076685, filed on Feb. 17, 2023, and claims the priority benefit of Chinese Patent Application No. 202210180223.5, filed on Feb. 26, 2022, the full disclosure of which is incorporated herein by reference.

### BACKGROUND

### Technical Field

The present application relates to transmission methods and devices in wireless communication systems, and in particular to a transmission scheme and device for uplink power control reporting in wireless communications.

### Related Art

5G wireless cellular communication network system (5G-RAN) has enhanced uplink power control of UE (User Equipment) on the basis of the original Long-Term Evolution (LTE). Compared to LTE, since the 5G NR system does not have a CRS (Common Reference Signal), pathloss measurement required for uplink power control needs to be performed by using CSI-RS (Channel State Information Reference Signal) and SSB (SS/PBCH Block). In addition, the biggest feature of the NR system is the introduction of the beam management mechanism, the terminal can communicate with multiple different transmitting and receiving beams, and thus the terminal needs to be able to measure multiple pathloss corresponding to multiple beams, in which one way to determine the pathloss is to indicate to some associated downlink RS (Reference Signal) resources through an SRI (Sounding Reference Signal Resource Indicator) in DCI (Downlink Control Information).

In the discussion of NR R17, the scenario of multiple panels configured on the terminal side has been adopted, and the impact on power control incurred by the introduction of multiple panels needs to be considered accordingly.

### SUMMARY

In the discussion of NR R17, enhancements have been made to the terminal's transmissions, one important aspect of which is the introduction of two panels, which can be employed by the terminal to transmit simultaneously on two transmit beams to obtain better spatial diversity gain. However, one of the important metrics for uplink transmission is power control. Existing PHRs (Power Headroom Report) are designed based on the case of one Panel, and the UE can calculate the reported PH (Power Headroom) according to a last transmitted PUSCH (Physical Uplink Shared Channel) or a referenced PUSCH, after the introduction of two Panels, how the UE reports the PHR needs to be reconsidered.

The present application discloses a solution for the problem of uplink power control in the multi-panel scenario. It should be noted that in the description of the present application, multi-panel is only used as a typical application scenario or example; the present application is equally applicable to other scenarios facing similar problems, such as single-panel scenarios, or for different technical fields, such as technical fields other than uplink power control, including measuring report field, uplink data transmission and other non-uplink power control fields to achieve similar technical results. Additionally, the adoption of a unified solution for various scenarios, including but not limited to scenarios of multi-panel, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:
receiving a first information set, the first information set being used to indicate a first reference signal resource set and a second reference signal resource set; and
transmitting a target signal, the target signal comprising a second information set;
herein, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, one feature of the above method is in: implementing that the first node shares a transmit power value between two Panels.

In one embodiment, another feature of the above method is in: the first power difference value is simultaneously related to the first reference signal resource set and the second reference signal resource set, thereby reducing the overhead of PHR signaling.

According to one aspect of the present application, the second information set comprises a second power difference value, and the second power difference value is equal to a difference value of a second target power value minus a second reference power value; the second reference power value is associated with a first reference signal resource set, or the second reference power value is associated with the second reference signal resource set.

In one embodiment, one feature of the above method is in: the second information set comprises two PH values at the same time, namely the first power difference value and the second power difference value, which provide more information for the base station.

According to one aspect of the present application, the target signal comprises two sub-signals that are respectively associated with the first reference signal resource set and the second reference signal resource set and are overlapping in time-frequency domain, and the second information set comprises the first power difference value and the second power difference value at the same time.

In one embodiment, one feature of the above method is in: establishing a connection between the transmission method of the target signal and a number of reported PHs comprised in the second information set, in order to reduce signaling overhead and improve transmission efficiency.

According to one aspect of the present application, comprising:
transmitting a first signal in a first time window;
herein, the target signal comprises two sub-signals that are respectively associated with the first reference signal resource set and the second reference signal resource set and are overlapping in time-frequency domain; a transmit power value of the first signal is the first reference power value.

According to one aspect of the present application, comprising:
transmitting a second signal in a second time window;
herein, the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

According to one aspect of the present application, comprising:
performing a channel measurement in a third reference signal resource set and a channel measurement in a fourth reference signal resource set; and determining that a pathloss variation value set satisfies a first condition;
herein, the third reference signal resource set is associated with the first reference signal resource set, and the fourth reference signal resource set is associated with the second reference signal resource set; at least one of the channel measurement in the third reference signal resource set or the channel measurement in the fourth reference signal resource set is used to generate the pathloss variation value set.

According to one aspect of the present application, the channel measurement in the third reference signal resource set is used to determine the first pathloss variation value, and the channel measurement in the fourth reference signal resource set is used to determine the second pathloss variation value, the meaning of the pathloss variation value set satisfying the first condition comprises that the first pathloss variation value is greater than a first threshold, or the meaning of the pathloss variation value set satisfying the first condition comprises that the second pathloss variation value is greater than a second threshold, or the meaning of the pathloss variation value set satisfying the first condition comprises that the first pathloss variation value is greater than a third threshold and the second pathloss variation value is greater than a fourth threshold.

In one embodiment, one feature of the above method is in: configuring flexible criteria to trigger reporting of PHR.

The present application provides a method in a second node for wireless communications, comprising:
transmitting a first information set, the first information set being used to indicate a first reference signal resource set and a second reference signal resource set; and
receiving a target signal, the target signal comprising a second information set;
herein, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

According to one aspect of the present application, the second information set comprises a second power difference value, and the second power difference value is equal to a difference value of a second target power value minus a second reference power value; the second reference power value is associated with a first reference signal resource set, or the second reference power value is associated with the second reference signal resource set.

According to one aspect of the present application, the target signal comprises two sub-signals that are respectively associated with the first reference signal resource set and the second reference signal resource set and are overlapping in time-frequency domain, and the second information set comprises the first power difference value and the second power difference value at the same time.

According to one aspect of the present application, comprising:
receiving a first signal in a first time window;
herein, the target signal comprises two sub-signals that are respectively associated with the first reference signal resource set and the second reference signal resource set and are overlapping in time-frequency domain; a transmit power value of the first signal is the first reference power value.

According to one aspect of the present application, comprising:
receiving a second signal in a second time window;
herein, the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

According to one aspect of the present application, comprising:
transmitting a reference signal in a third reference signal resource set and transmitting a reference signal in a fourth reference signal resource set;
herein, the third reference signal resource set is associated with the first reference signal resource set, and the fourth reference signal resource set is associated with the second reference signal resource set; at least one of the channel measurement in the third reference signal resource set or the channel measurement in the fourth reference signal resource set is used by a transmitter of the target signal to generate the pathloss variation value set, and the pathloss variation value set satisfies a first condition.

According to one aspect of the present application, the channel measurement in the third reference signal resource set is used to determine the first pathloss variation value, and the channel measurement in the fourth reference signal resource set is used to determine the second pathloss variation value, the meaning of the pathloss variation value set satisfying the first condition comprises that the first pathloss variation value is greater than a first threshold, or the meaning of the pathloss variation value set satisfying the first condition comprises that the second pathloss variation value is greater than a second threshold, or the meaning of the pathloss variation value set satisfying the first condition comprises that the first pathloss variation value is greater than a third threshold and the second pathloss variation value is greater than a fourth threshold.

The present application provides a first node for wireless communications, comprising:
a first receiver, receiving a first information set, the first information set being used to indicate a first reference signal resource set and a second reference signal resource set; and
a first transmitter, transmitting a target signal, the target signal comprising a second information set;
herein, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

The present application provides a second node for wireless communications, comprising:
a second transmitter, transmitting a first information set, the first information set being used to indicate a first reference signal resource set and a second reference signal resource set; and
a second receiver, receiving a target signal, the target signal comprising a second information set;
herein, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, advantages of the scheme in the present application are: improving the efficiency of PHR reporting, reducing signaling overhead, and avoiding waste of uplink resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a target signal according to one embodiment of the present application;

FIG. 6 illustrates a flowchart of a first signal according to one embodiment of the present application;

FIG. 7 illustrates a flowchart of a second signal according to one embodiment of the present application;

FIG. 8 illustrates a flowchart of channel measurement according to one embodiment of the present application;

FIG. 9 illustrates a schematic diagram of a first reference signal resource set and a second reference signal resource set according to one embodiment of the present application;

FIG. 10 illustrates a schematic diagram of a third reference signal resource set and a fourth reference signal resource set according to one embodiment of the present application;

FIG. 11 illustrates a schematic diagram of a first node according to one embodiment of the present application;

FIG. 12 illustrates a schematic diagram of antenna ports and antenna port groups according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

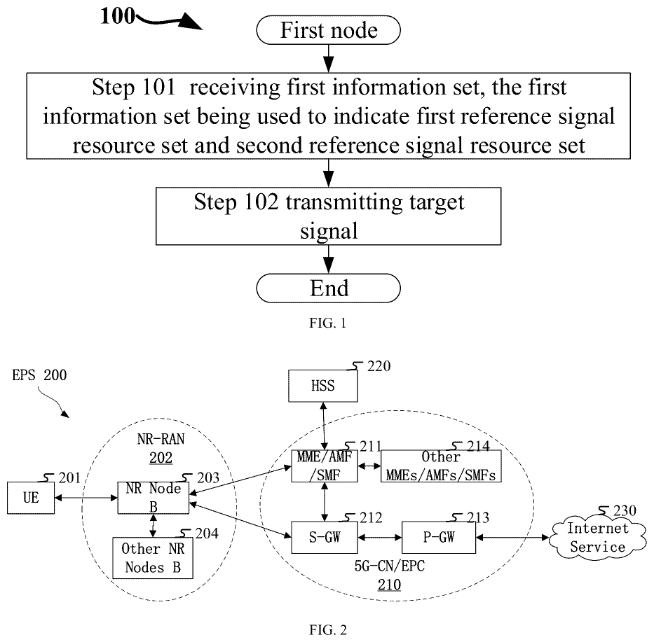

Embodiment 1 illustrates a flowchart of the processing of a first node, as shown in FIG. 1. In step 100 illustrated by FIG. 1, each box represents a step. In embodiment 1, the first node in the present application receives a first information set in step 101, and the first information set is used to indicate a first reference signal resource set and a second reference signal resource set; transmits a target signal in step 102, the target signal comprises a second information set.

In embodiment 1, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the first information set is transmitted through a Radio Resource Control (RRC) signaling.

In one embodiment, the first information set is configured through an RRC signaling.

In one embodiment, an RRC signaling for transmitting or configuring the first information set comprises one or multiple fields in PUSCH-PowerControl in Specification.

In one embodiment, an RRC signaling for transmitting or configuring the first information set comprises PUSCH-PowerControl in Specification.

In one embodiment, an RRC signaling for transmitting or configuring the first information set comprises PUSCH-PO-PUSCH-AlphaSet in Specification.

In one embodiment, an RRC signaling for transmitting or configuring the first information set comprises one or multiple fields in SRI-PUSCH-PowerControl in Specification.

In one embodiment, an RRC signaling for transmitting or configuring the first information set comprises SRI-PUSCH-PowerControl in Specification.

In one embodiment, an RRC signaling for transmitting or configuring the first information set comprises one or multiple fields in CSI-ResourceConfig in Specification.

In one embodiment, an RRC signaling for transmitting or configuring the first information set comprises one or multiple fields in CSI-SSB-ResourceSet in Specification.

In one embodiment, an RRC signaling for transmitting or configuring the first information set comprises one or multiple fields in SRS-Config in Specification.

In one embodiment, a name of an RRC signaling for transmitting or configuring the first information set comprises Power.

In one embodiment, a name of an RRC signaling for transmitting or configuring the first information set comprises Control.

In one embodiment, a name of an RRC signaling for transmitting or configuring the first information set comprises PUSCH.

In one embodiment, a name of an RRC signaling for transmitting or configuring the first information set comprises CSI (Channel State Information).

In one embodiment, a name of an RRC signaling for transmitting or configuring the first information set comprises CSI-RS.

In one embodiment, a name of an RRC signaling for transmitting or configuring the first information set comprises SRS.

In one embodiment, a name of an RRC signaling for transmitting or configuring the first information set comprises SRI.

In one embodiment, the first reference signal resource set is identified by SRS-ResourceSetId.

In one embodiment, the first reference signal resource set corresponds to an SRS resource set.

In one embodiment, the first reference signal resource set comprises a reference signal resource.

In one subembodiment of the embodiment, the reference signal resource comprised in the first reference signal resource set is an SRS Resource.

In one subembodiment of the embodiment, the reference signal resource comprised in the first reference signal resource set is a CSI-RS resource.

In one subembodiment of the embodiment, the reference signal resource comprised in the first reference signal resource set is an SSB.

In one embodiment, the first reference signal resource set comprises K1 first-type reference signal resource(s), K1 being a positive integer.

In one subembodiment of the embodiment, the K1 is equal to 1.

In one subembodiment of the embodiment, the K1 is greater than 1.

In one subembodiment of the embodiment, any of the K1 first-type reference signal resource(s) comprised in the first reference signal resource set is an SRS Resource.

In one subembodiment of the embodiment, there at least exists one of the K1 first-type reference signal resource(s) comprised in the first reference signal resource set being an SRS Resource.

In one subembodiment of the embodiment, any of the K1 first-type reference signal resource(s) comprised in the first reference signal resource set is a CSI-RS Resource.

In one subembodiment of the embodiment, any of the K1 first-type reference signal resource(s) comprised in the first reference signal resource set is an SSB.

In one embodiment, the second reference signal resource set is identified by SRS-ResourceSetId.

In one embodiment, the second reference signal resource set corresponds to an SRS resource set.

In one embodiment, the second reference signal resource set comprises a reference signal resource.

In one subembodiment of the embodiment, the reference signal resource comprised in the second reference signal resource set is an SRS Resource.

In one subembodiment of the embodiment, the reference signal resource comprised in the second reference signal resource set is a CSI-RS resource.

In one subembodiment of the embodiment, the reference signal resource comprised in the second reference signal resource set is an SSB.

In one embodiment, the second reference signal resource set comprises K2 reference signal resources, K2 being a positive integer.

In one subembodiment of the above embodiment, the K2 is equal to 1.

In one subembodiment of the above embodiment, the K2 is greater than 1.

In one subembodiment of the embodiment, any of the K2 second-type reference signal resource(s) comprised in the second reference signal resource set is an SRS Resource.

In one subembodiment of the embodiment, there at least exists one of the K2 second-type reference signal resource(s) comprised in the second reference signal resource set being an SRS Resource.

In one subembodiment of the embodiment, any of the K2 second-type reference signal resource(s) comprised in the second reference signal resource set is a CSI-RS Resource.

In one subembodiment of the embodiment, any of the K2 second-type reference signal resource(s) comprised in the second reference signal resource set is an SSB.

In one embodiment, a physical-layer channel occupied by the target signal comprises a PUSCH.

In one embodiment, a physical-layer channel occupied by the target signal comprises a PUCCH.

In one embodiment, the target signal comprises a Medium Access Control (MAC) Control Element (CE).

In one embodiment, the target signal comprises a PHR, and the PHR comprised in the target signal comprises one or multiple PH values.

In one embodiment, the first power difference value is measured by dBm.

In one embodiment, the first power difference value is measured by dB.

In one embodiment, the first power difference value is measured by mW.

In one embodiment, the second information set comprises a power difference value.

In one embodiment, the second information set comprises two power difference values.

In one embodiment, a number of power difference value(s) comprised in the second information set is related to whether the target signal comprises two sub-signals that are respectively associated with the first reference signal resource set and the second reference signal resource set and are overlapping in time-frequency domain.

In one subembodiment of the embodiment, the target signal comprises two sub-signals that are respectively associated with the first reference signal resource set and the second reference signal resource set and are overlapping in time-frequency domain, and the second information set comprises two power difference values.

In one subsidiary embodiment of the subembodiment, the two power difference values comprised in the second information set are respectively the first power difference value and the second power difference value.

In one subembodiment of the embodiment, the target signal does not comprise two sub-signals that are respectively associated with the first reference signal resource set and the second reference signal resource set and are overlapping in time-frequency domain, and the second information set only comprises one power difference value.

In one subembodiment of the embodiment, the target signal only comprises a sub-signal associated with either the first reference signal resource set or the second reference signal resource set, and the second information set only comprises a power difference value.

In one subsidiary embodiment of the subembodiment, the power difference value comprised in the second information set is the second power difference value.

In one embodiment, the second information set generates a MAC CE.

In one embodiment, the first power value and the second power value are respectively transmit power values adopted by the first node to transmit a radio signal generated by a TB on a spatial Tx parameter corresponding to a reference signal resource in the first reference signal resource set and to transmit a radio signal generated by a TB on a spatial Tx parameter corresponding to a reference signal resource in the second reference signal resource set at the same time.

In one embodiment, the first power value is associated with a first reference signal resource in K1 first-type reference signal resource(s) comprised in the first reference signal resource set, and the second power value is associated with a second reference signal resource in K2 second-type reference signal resource(s) comprised in the second reference signal resource set.

In one embodiment, the first power value and the second power value are power values respectively adopted by the first node to transmit two radio sub-signals at the same time on a spatial Tx parameter corresponding to a reference signal resource in the first reference signal resource set and on a spatial Tx parameter corresponding to a reference signal resource in the second reference signal resource set.

In one embodiment, the first reference signal resource in the first reference signal resource set is associated with a given CSI-RS resource, and channel quality obtained for a radio signal measured in the given CSI-RS resource is used to determine the first power value, the channel quality comprising pathloss.

In one embodiment, the first reference signal resource in the first reference signal resource set is associated with a given SSB, and channel quality obtained for a radio signal measured in the given SSB is used to determine the first power value, the channel quality comprising pathloss.

In one embodiment, the second reference signal resource in the second reference signal resource set is associated with a given CSI-RS resource, and channel quality obtained for a radio signal measured in the given CSI-RS resource is used to determine the second power value, the channel quality comprising pathloss.

In one embodiment, the second reference signal resource in the second reference signal resource set is associated with a given SSB, and channel quality obtained for a radio signal measured in the given SSB is used to determine the second power value, the channel quality comprising pathloss.

In one embodiment, the first target power value is P_{CMAX,f,c}(i) in Specification.

In one embodiment, the first target power value is P_{CMAX,f,c}(i) in Specification.

In one embodiment, the first target power value is a maximum transmit power value that the first node can adopt.

In one embodiment, the first target power value is a maximum transmit power value that the first node can adopt when transmitting radio signals on two panels at the same time.

In one embodiment, the first target power value is pre-defined.

In one embodiment, the first target power value is fixed.

In one embodiment, the first target power value is related to capability of the first node.

In one embodiment, the first target power value is related to Category of the first node.

In one embodiment, the first target power value is simultaneously associated with the first reference signal resource set and the second reference signal resource set.

In one embodiment, configuration information of the first target power value comprises an ID corresponding to the first reference signal resource set and an ID corresponding to the second reference signal resource set.

In one embodiment, when the target signal comprises two sub-signals that are respectively associated with the first reference signal resource set and the second reference signal resource set and are overlapping in time-frequency domain, and the two sub-signals comprised in the target signal are respectively associated with the first reference signal resource set or the second reference signal resource set.

In one subembodiment of the embodiment, a first-type reference signal resource in the first reference signal resource set and a second-type reference signal resource in the second reference signal resource set are respectively used to determine spatial Tx parameters of the two sub-signals comprised in the target signal.

In one subembodiment of the embodiment, a reference signal transmitted in a first-type reference signal resource in the first reference signal resource set and a reference signal transmitted in a second-type reference signal resource in the second reference signal resource set are QCLed with the two sub-signals comprised in the target signal.

In one embodiment, the first target power value is measured by dBm.

In one embodiment, the first target power value is measured by dB.

In one embodiment, the first target power value is measured by mW.

In one embodiment, the first reference power value is measured by dBm.

In one embodiment, the first reference power value is measured by dB.

In one embodiment, the first reference power value is measured by mW.

In one embodiment, the first power value is measured by dBm.

In one embodiment, the first power value is measured by dB.

In one embodiment, the first power value is measured by mW.

In one embodiment, the second power value is measured by dBm.

In one embodiment, the second power value is measured by dB.

In one embodiment, the second power value is measured by mW.

In one embodiment, a physical-layer channel occupied by the sub-signal in the present application comprises PUSCH.

In one embodiment, the sub-signal in the present application is generated by a TB.

In one embodiment, the sub-signal in the present application occupies one HARQ process number.

In one embodiment, the sub-signal in the present application occupies a PUSCH.

In one embodiment, the channel quality in the present application comprises pathloss.

In one embodiment, the channel quality in the present application comprises RSRP (Reference Signal Received Power).

In one embodiment, the channel quality in the present application comprises at least one of RSRQ (Reference Signal Received Quality), RSSI (Received Signal Strength Indicator), SNR (Signal to Noise Ratio), or SINR (Signal to Interference plus Noise Ratio).

In one embodiment, the first reference signal resource in the present application is an SRS resource.

In one embodiment, the first reference signal resource in the present application corresponds to an SRS-ResourceID.

In one embodiment, the second reference signal resource in the present application is an SRS resource.

In one embodiment, the second reference signal resource in the present application corresponds to an SRS-ResourceID.

In one embodiment, the second information set comprises a first field, the first field is used to indicate ServCellIndex of a serving cell corresponding to a given power difference value, the given power difference value is either the first power difference value or the second power difference value; the first power difference value and the second power difference value correspond to a same serving cell.

In one embodiment, the second information set comprises a second field, the second field is used to indicate whether a given power difference value is based on an actual transmission or a reference format, and the given power difference value is either the first power difference value or the second power difference value.

In one embodiment, the second information set comprises a third field, the third field is used to indicate whether a reference signal resource set associated with a given power difference value is the first reference signal resource set or the second reference signal resource set, and the given power difference value is either the first power difference value or the second power difference value.

In one embodiment, the second information set comprises a fourth field, the fourth field is used to indicate whether a given power difference value is adopted based on one of the first reference signal resource set or the second reference signal resource set, or adopted based on both the first reference signal resource set and second reference signal resource set, and the given power difference value is either the first power difference value or the second power difference value.

In one embodiment, corresponding to ServCellIndex of a given serving cell, when the second information set comprises the first power difference value and the second power difference value, a relative position between the first power difference value and the second power difference value is fixed.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports simultaneous transmission of multiple panels.

In one embodiment, the UE 201 supports power sharing between multiple panels.

In one embodiment, the UE 201 supports multiple uplink RF (Radio Frequency).

In one embodiment, the UE 201 supports simultaneous transmission of multiple uplink RE

In one embodiment, the UE 201 supports reporting multiple sets of UE capability values.

In one embodiment, the NR node B corresponds to the second node in the present application.

In one embodiment, the NR node B supports receiving signals from multiple panels from a terminal at the same time.

In one embodiment, the NR node B supports receiving a signal transmitted by multiple uplink RF (Radio Frequency) from a same terminal.

In one embodiment, the NR node B is a base station.

In one embodiment, the NR node B is a cell.

In one embodiment, the NR node B comprises multiple cells.

In one embodiment, the first node in the present application corresponds to the UE 201, and the second node in the present application corresponds to the NR node B.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information set is generated by the MAC 302 or the MAC 352.

In one embodiment, the first information set is generated by the RRC 306.

In one embodiment, the second information set is generated by the MAC 302 or the MAC 352.

In one embodiment, the second information set is generated by the RRC 306.

In one embodiment, the target signal is generated by the PHY 301 or the PHY 351.

In one embodiment, the target signal is generated by the MAC 302 or the MAC 352.

In one embodiment, the target signal is generated by the RRC 306.

In one embodiment, the first signal is generated by the PHY 301 or the PHY 351.

In one embodiment, the first signal is generated by the MAC 302 or the MAC 352.

In one embodiment, the first signal is generated by the RRC 306.

In one embodiment, the second signal is generated by the PHY 301 or the PHY 351.

In one embodiment, the second signal is generated by the MAC 302 or the MAC 352.

In one embodiment, the second signal is generated by the RRC 306.

In one embodiment, a reference signal transmitted in the first reference signal resource set is generated by either the PHY 301 or the PHY 351.

In one embodiment, a reference signal transmitted in the first reference signal resource set is generated by either the MAC 302 or the MAC 352.

In one embodiment, a reference signal transmitted in the first reference signal resource set is generated by the RRC 306.

In one embodiment, a reference signal transmitted in the second reference signal resource set is generated by either the PHY 301 or the PHY 351.

In one embodiment, a reference signal transmitted in the second reference signal resource set is generated by either the MAC 302 or the MAC 352.

In one embodiment, a reference signal transmitted in the second reference signal resource set is generated by the RRC 306.

In one embodiment, a reference signal transmitted in the third reference signal resource set is generated by either the PHY 301 or the PHY 351.

In one embodiment, a reference signal transmitted in the third reference signal resource set is generated by either the MAC 302 or the MAC 352.

In one embodiment, a reference signal transmitted in the third reference signal resource set is generated by the RRC 306.

In one embodiment, a reference signal transmitted in the fourth reference signal resource set is generated by either the PHY 301 or the PHY 351.

In one embodiment, a reference signal transmitted in the fourth reference signal resource set is generated by either the MAC 302 or the MAC 352.

In one embodiment, a reference signal transmitted in the fourth reference signal resource set is generated by the RRC 306.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used to manage multiple TRPs.

In one embodiment, the second node is a node to manage multiple cells.

### Embodiment 4

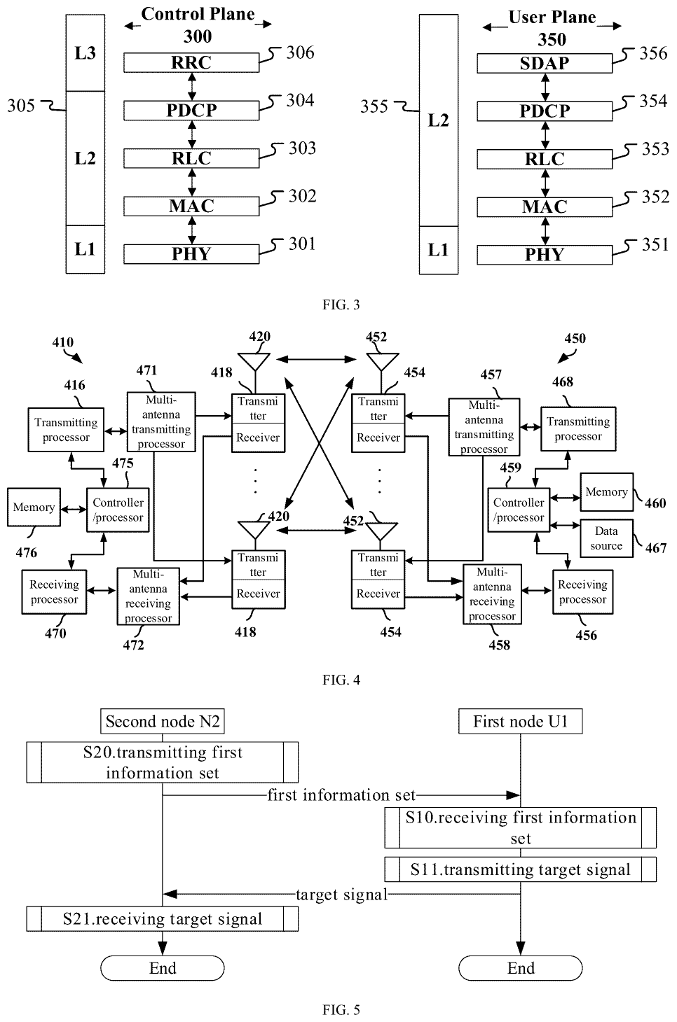

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first information set, the first information set is used to indicate a first reference signal resource set and a second reference signal resource set; then transmits a target signal, the target signal comprises a second information set; the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the first communication device 450 comprises at least one processor and at least one memory. a memory that stores a computer readable instruction program. The computer readable instruction program generates an action when executed by at least one processor. The action includes: first receiving a first information set, the first information set being used to indicate a first reference signal resource set and a second reference signal resource set; then transmitting a target signal, the target signal comprising a second information set; the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first information set, the first information set is used to indicate a first reference signal resource set and a second reference signal resource set; then receives a target signal, the target signal comprises a second information set; the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the second communication device 410 comprises a memory that stores a computer readable instruction program. The computer readable instruction program generates an action when executed by at least one processor. The action includes: first transmitting a first information set, the first information set being used to indicate a first reference signal resource set and a second reference signal resource set; then receiving a target signal, the target signal comprising a second information set; the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first information set; at least first four of the antenna 420, the transmitter 418, the multi-antenna transmitting processor 471, the transmitting processor 416 and the controller/processor 475 are used to transmit a first information set.

In one embodiment, at least first four of the antenna 452, the transmitter 454, the multi-antenna transmitting processor 457, the transmitting processor 468, and the controller/processor 459 are used to transmit a target signal; at least first four of the antenna 420, the receiver 418, the multi-antenna receiving processor 472, the receiving processor 470 and the controller/processor 475 are used to receive a target signal.

In one embodiment, at least first four of the antenna 452, the transmitter, the multi-antenna transmitting processor 457, the transmitting processor 468, and the controller/processor 459 are used to transmit a first signal in a first time window; at least first four of the antenna 420, the receiver 418, the multi-antenna receiving processor 472, the receiving processor 470 and the controller/processor 475 are used to receive a first signal in a first time window.

In one embodiment, at least first four of the antenna 452, the transmitter 454, the multi-antenna transmitting processor 457, the transmitting processor 468, and the controller/processor 459 are used to transmit a second signal in a second time window; at least first four of the antenna 420, the receiver 418, the multi-antenna receiving processor 472, the receiving processor 470 and the controller/processor 475 are used to receive a second signal in a second time window.

In one embodiment, at least first four of the antenna 452, the receiver 454, the multi-antenna receiving processor 458, the receiving processor 456 and the controller/processor 459 are used to perform a channel measurement in a third reference signal resource set and perform a channel measurement in a fourth reference signal resource set; and determine that a pathloss variation value set satisfies a first condition; at least first four of the antenna 420, the transmitter 418, the multi-antenna transmitting processor 471, the transmitting processor 416 and the controller/processor 475 are used to transmit a reference signal in a third reference signal resource set, and transmit a reference signal in a fourth reference signal resource set.

### Embodiment 5

Embodiment 5 illustrates a flowchart of a target signal, as shown in FIG. 5. In FIG. 5, a first node U1 and a second node N2 are in communications via a radio link. It is particularly underlined that the order illustrated in the embodiment does not put constraints over sequences of signal transmissions and implementations. Embodiments, sub-embodiments and subsidiary embodiments of embodiment 5 can be applied to any of embodiment 6, 7 or 8 if no conflict is caused; on the contrary, without conflict, any of embodiments, sub-embodiments, and subsidiary embodiments of embodiments 6, 7, or 8 are capable of being applied to embodiment 5.

The first node U1 receives a first information set in step S10; transmits a target signal in step S11.

The second node N2 transmits a first information set in step S20; receives a target signal in step S21.

In embodiment 5, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

Typically, the second information set comprises a second power difference value, and the second power difference value is equal to a difference value of a second target power value minus a second reference power value; the second reference power value is associated with a first reference signal resource set, or the second reference power value is associated with the second reference signal resource set.

In one embodiment, the second reference power value is associated with only a target reference signal resource set in the first reference signal resource set and the second reference signal resource set, where the target reference signal resource set is a default one in the first reference signal resource set and the second reference signal resource set.

In one subembodiment of the embodiment, the target reference signal resource set is a smaller one corresponding to SRS-ResourceSetId in the first reference signal resource set and the second reference signal resource set.

In one embodiment, the second target power value is measured by dBm.

In one embodiment, the second target power value is measured by dB.

In one embodiment, the second target power value is measured by mW.

In one embodiment, the second reference power value is measured by dBm.

In one embodiment, the second reference power value is measured by dB.

In one embodiment, the second reference power value is measured by mW.

In one embodiment, the second target power value is P_{CMAX,f,c}(i) in Specification.

In one embodiment, the second target power value is P_{CMAX,f,c}(i) in Specification.

In one embodiment, the second target power value is a maximum transmit power value that the first node can adopt.

In one embodiment, the second target power value is a maximum transmit power value that the first node can adopt when transmitting a radio signal on a panel.

In one embodiment, the second target power value is pre-defined.

In one embodiment, the second target power value is fixed.

In one embodiment, the second target power value is related to capability of the first node.

In one embodiment, the second target power value is related to Category of the first node.

In one embodiment, when the second reference power value is associated with the first reference signal resource set, the second target power value is associated with the first reference signal resource set.

In one embodiment, when the second reference power value is associated with the second reference signal resource set, the second target power value is associated with the second reference signal resource set.

In one embodiment, when the second reference power value is associated with the first reference signal resource set, configuration information of the second target power value comprises an ID corresponding to the first reference signal resource set.

In one embodiment, when the second reference power value is associated with the second reference signal resource set, configuration information of the second target power value comprises an ID corresponding to the second reference signal resource set.

In one embodiment, when the second reference power value is associated with the first reference signal resource set, the second reference power value is a transmit power value used by the first node to transmit a radio signal generated by a TB only on a spatial Tx parameter corresponding to a reference signal resource in the first reference signal resource set.

In one embodiment, when the second reference power value is associated with the first reference signal resource set, the second reference power value is associated with a first reference signal resource in K1 first-type reference signal resource(s) comprised in the first reference signal resource set.

In one embodiment, when the second reference power value is associated with the first reference signal resource set, the second reference power value is a power value used by the first node to transmit one radio sub-signal on a spatial Tx parameter corresponding to a reference signal resource in the first reference signal resource set.

In one embodiment, when the second reference power value is associated with the first reference signal resource set, the first reference signal resource in the first reference signal resource set is associated with a given CSI-RS resource, and channel quality obtained for a radio signal measured in the given CSI-RS resource is used to determine the second reference power value, the channel quality comprising pathloss.

In one embodiment, when the second reference power value is associated with the first reference signal resource set, the first reference signal resource in the first reference signal resource set is associated with a given SSB, and channel quality obtained for a radio signal measured in the given SSB is used to determine the second reference power value, the channel quality comprising pathloss.

In one embodiment, when the second reference power value is associated with the second reference signal resource set, the second reference power value is a transmit power value used by the first node to transmit a radio signal generated by a TB only on a spatial Tx parameter corresponding to a reference signal resource in the second reference signal resource set.

In one embodiment, when the second reference power value is associated with the second reference signal resource set, the second reference power value is associated with a second reference signal resource in K2 second-type reference signal resource(s) comprised in the second reference signal resource set.

In one embodiment, when the second reference power value is associated with the second reference signal resource set, the second reference power value is a power value used by the first node to transmit a radio sub-signal on a spatial Tx parameter corresponding to a reference signal resource in the second reference signal resource set.

In one embodiment, when the second reference power value is associated with the second reference signal resource set, the second reference signal resource in the second reference signal resource set is associated with a given CSI-RS resource, and channel quality obtained for a radio signal measured in the given CSI-RS resource is used to determine the second reference power value, the channel quality comprising pathloss.

In one embodiment, when the second reference power value is associated with the second reference signal resource set, the second reference signal resource in the second reference signal resource set is associated with a given SSB, and channel quality obtained for a radio signal measured in the given SSB is used to determine the second reference power value, the channel quality comprising pathloss.

In one embodiment, the target signal comprises two sub-signals that are respectively associated with the first reference signal resource set and the second reference signal resource set and are overlapping in time-frequency domain, and the second information set comprises the first power difference value and the second power difference value at the same time.

In one embodiment, when and only when the target signal comprises two sub-signals that are respectively associated with the first reference signal resource set and the second reference signal resource set and are overlapping in time-frequency domain, and the second information set comprises the first power difference value and the second power difference value at the same time.

In one embodiment, the two sub-signals comprised in the target signal are SD (Space Division Multiplexing).

In one embodiment, the two sub-signals comprised in the target signal occupy same time-domain resources.

In one embodiment, the two sub-signals comprised in the target signal occupy same frequency-domain resources.

In one embodiment, the two sub-signals comprised in the target signal occupy a same RE.

In one embodiment, the two sub-signals comprised in the target signal are generated by two different TBs.

In one embodiment, the target signal is triggered by a DCI.

In one embodiment, the target signal is scheduled by a DCI.

In one embodiment, a given first-type reference signal resource in the K1 first-type reference signal resource(s) comprised in the first reference signal resource set is associated with the first power value.

In one subembodiment of the embodiment, the given first-type reference signal resource is predefined.

In one subembodiment of the embodiment, a position of the given first-type reference signal resource in the K1 first-type reference signal resource(s) is fixed.

In one subembodiment of the embodiment, the given first-type reference signal resource is indicated by a scheduling signaling of the target signal.

In one subembodiment of the embodiment, P_{O_NOMINAL_PUSCH,f,c}(j) associated with the given first-type reference signal resource is used to determine the first power value.

In one subembodiment of the embodiment, PUSCH-AlphaSetId associated with the given first-type reference signal resource is used to determine the first power value.

In one subembodiment of the embodiment, pusch-PathlossReferenceRS-Id used to calculate pathloss adopted by the first power value corresponds to CSI-RS resources or SSB associated with the given first-type reference signal resource.

In one embodiment, a given second-type reference signal resource in the K2 second-type reference signal resource(s) comprised in the second reference signal resource set is associated with the second power value.

In one subembodiment of the embodiment, the given second-type reference signal resource is predefined.

In one subembodiment of the embodiment, a position of the given second-type reference signal resource in the K2 second-type reference signal resource(s) is fixed.

In one subembodiment of the embodiment, the given second-type reference signal resource is indicated by a scheduling signaling of the target signal.

In one subembodiment of the embodiment, P_{O_NOMINAL_PUSCH,f,c}(j) associated with the given second-type reference signal resource is used to determine the second power value.

In one subembodiment of the embodiment, PUSCH-AlphaSetId associated with the given second-type reference signal resource is used to determine the second power value.

In one subembodiment of the embodiment, pusch-PathlossReferenceRS-Id used to calculate pathloss adopted by the second power value corresponds to CSI-RS resources or SSB associated with the given second-type reference signal resource.

### Embodiment 6

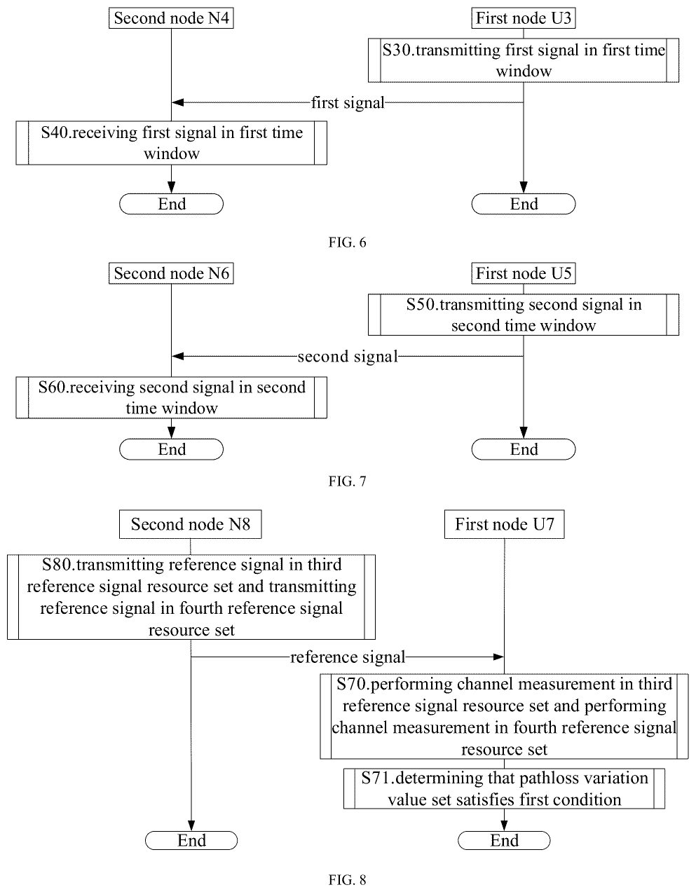

Embodiment 6 illustrates a flowchart of a first signal, as shown in FIG. 6. In FIG. 6, a first node U3 and a second node N4 are in communications via a radio link. It is particularly underlined that the order illustrated in the embodiment does not put constraints over sequences of signal transmissions and implementations. Embodiments, sub-embodiments and subsidiary embodiments of embodiment 6 can be applied to any of embodiment 5, 7 or 8 if no conflict is caused; on the contrary, without conflict, any of embodiments, sub-embodiments, and subsidiary embodiments of embodiments 5, 7, or 8 are capable of being applied to embodiment 6.

The first node U3 transmits a first signal in a first time window in step S30.

The second node N4 receives a first signal in a first time window in step S40.

In embodiment 6, the target signal comprises two sub-signals that are respectively associated with the first reference signal resource set and the second reference signal resource set and are overlapping in time-frequency domain; a transmit power value of the first signal is the first reference power value.

In one embodiment, the first time window is earlier than time-domain resources occupied by the target signal in time domain.

In one embodiment, the first time window is for reporting of PHR when the first reference signal resource set and the second reference signal resource set are used for uplink transmission at the same time.

In one embodiment, the first signal is scheduled by DCI.

In one embodiment, the first signal is indicated by DCI.

In one embodiment, the first time window is independently configured.

In one embodiment, the first time window is configured through an RRC signaling.

In one embodiment, transmit power values of two sub-signals that are respectively associated with the first reference signal resource set and the second reference signal resource set and are overlapping in time-frequency domain comprised in the first signal are the first power value and the second power value, respectively.

In one embodiment, a physical-layer channel occupied by the first signal comprises a PUSCH.

In one embodiment, two sub-signals comprised in the first signal occupy two PUSCHs respectively.

In one embodiment, two sub-signals comprised in the first signal are respectively QCLed with two sub-signals comprised in the target signal.

In one embodiment, two sub-signals comprised in the first signal are respectively QCLed with a reference signal transmitted from a first-type reference signal resource in the first reference signal resource set, and a reference signal transmitted from a second-type reference signal resource in the second reference signal resource set.

In one embodiment, two sub-signals comprised in the first signal are respectively QCLed with a reference signal transmitted from the first reference signal resource in the first reference signal resource set, and a reference signal transmitted from the second reference signal resource in the second reference signal resource set.

In one embodiment, the step S30 is taken after the step S10 and before the step S11 in embodiment 5.

In one embodiment, the step S40 is taken after the step S20 and before the step S21 in embodiment 5.

### Embodiment 7

Embodiment 7 illustrates a flowchart of a second signal, as shown in FIG. 7. In FIG. 7, a first node U5 and a second node N6 are in communications via a radio link. It is particularly underlined that the order illustrated in the embodiment does not put constraints over sequences of signal transmissions and implementations. Without conflict, embodiments, sub-embodiments, and subsidiary embodiments of embodiment 7 are capable of being applied to any of embodiments 5, 6, or 8; conversely, without conflict, any of embodiments, sub-embodiments, and subsidiary embodiments of embodiments 5, 6, or 8 are capable of being applied to embodiment 7.

The first node U5 transmits a second signal in a second time window in step S50.

The second node N6 receives a second signal in a second time window in step S60.

In embodiment 7, the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

In one embodiment, the second time window is earlier than time-domain resources occupied by the target signal in time domain.

In one embodiment, the second time window is used for reporting of PHR when either the first reference signal resource set or the second reference signal resource set is used for uplink transmission.

In one embodiment, there exists an overlapping between the first time window and the second time window in time domain.

In one embodiment, the first time window and the second time window are orthogonal in time domain.

In one embodiment, the second time window is independently configured.

In one embodiment, the second time window is configured through an RRC signaling.

In one embodiment, the second signal is scheduled by DCI.

In one embodiment, the second signal is indicated by DCI.

In one embodiment, the first signal and the second signal are respectively scheduled by different DCIs.

In one embodiment, the first signal and the second signal are respectively indicated by different DCIs.

In one embodiment, a transmit power value of the second signal is the second reference power value.

In one embodiment, a physical-layer channel occupied by the second signal comprises a PUSCH.

In one embodiment, when the second signal is associated with the first reference signal resource set, the second signal and a first-type reference signal resource in the first reference signal resource set are QCLed.

In one embodiment, when the second signal is associated with the second reference signal resource set, the second signal and a second-type reference signal resource in the first reference signal resource set are QCLed.

In one embodiment, when the second signal is associated with the first reference signal resource set, the second signal and the first reference signal resource in the first reference signal resource set are QCLed.

In one embodiment, when the second signal is associated with the second reference signal resource set, the second signal and the second reference signal resource in the first reference signal resource set are QCLed.

In one embodiment, the second signal and the second reference power value are both associated with the first reference signal resource set and the first reference signal resource set in the second reference signal resource set.

In one embodiment, the second signal and the second reference power value are both associated with the first reference signal resource set and the second reference signal resource set in the second reference signal resource set.

In one embodiment, the step S50 is taken after step S10 and before step S11 in embodiment 5.

In one embodiment, the step S60 is taken after step S20 and before step S21 in embodiment 5.

In one embodiment, the step S50 is taken after step S30 in Embodiment 6.

In one embodiment, the step S60 is taken after step S40 in Embodiment 6.

In one embodiment, the step S50 is taken before step S30 in Embodiment 6.

In one embodiment, the step S60 is taken before step S40 in Embodiment 6.

### Embodiment 8

Embodiment 8 illustrates a schematic diagram of a channel measurement, as shown in FIG. 8. In FIG. 8, a first node U7 and a second node N8 are in communication via a radio link. It is particularly underlined that the order illustrated in the embodiment does not put constraints over sequences of signal transmissions and implementations. Without conflict, embodiments, sub-embodiments, and subsidiary embodiments of embodiment 8 are capable of being applied to any of embodiments 5, 6, or 7; conversely, without conflict, any of embodiments, sub-embodiments, and subsidiary embodiments of embodiments 5, 6, or 7 are capable of being applied to embodiment 8.

The first node U7 performs a channel measurement in a third reference signal resource set and a channel measurement in a fourth reference signal resource set in step S70; and determines that a pathloss variation value set satisfies a first condition in step S71.

The second node N8 transmits a reference signal in a third reference signal resource set and transmits a reference signal in a fourth reference signal resource set in step S80.

In embodiment 8, the third reference signal resource set is associated with the first reference signal resource set, and the fourth reference signal resource set is associated with the second reference signal resource set; at least one of the channel measurement in the third reference signal resource set or the channel measurement in the fourth reference signal resource set is used to generate the pathloss variation value set.

In one embodiment, the step S70 comprises receiving a reference signal in the third reference signal resource set and receiving a reference signal in the fourth reference signal resource set.

In one subembodiment of the embodiment, the meaning of receiving a reference signal in the third reference signal resource set comprises: receiving one or multiple reference signals from one or multiple third-type reference signal resources in K3 third-type reference signal resource(s) comprised in the third reference signal resource set.

In one subembodiment of the embodiment, the meaning of receiving a reference signal in the fourth reference signal resource set comprises: receiving one or multiple reference signals from one or multiple fourth-type reference signal resource(s) in K4 fourth-type reference signal resource(s) comprised in the fourth reference signal resource set.

In one embodiment, the third reference signal resource set comprises K3 third-type reference signal resource(s), K3 being a positive integer.

In one subembodiment of the above embodiment, the K3 is equal to 1.

In one subembodiment of the above embodiment, the K3 is greater than 1.

In one subembodiment of the above embodiment, the K3 is equal to K1, and the K3 third-type reference signal resource(s) corresponds(correspond) one-to-one with the K1 first-type reference signal resource(s).

In one subsidiary embodiment of the subembodiment, a given third-type reference signal resource is any of the K3 third-type reference signal resource(s), the given third-type reference signal resource corresponds to a given first-type reference signal resource in the K1 first-type reference signal resource, and a radio signal transmitted in the given third-type reference signal resource is QCLed with a radio signal transmitted in the given first-type reference signal resource.

In one subembodiment of the above embodiment, there at least exists a radio signal transmitted in a third-type reference signal resource among the K3 third-type reference signal resource(s) and a radio signal transmitted in a first-type reference signal resource among the K1 first-type reference signal resource(s) being QCLed.

In one subembodiment of the embodiment, any of the K3 third-type reference signal resource(s) comprised in the third reference signal resource set is a CSI-RS Resource.

In one subembodiment of the above embodiment, any of the K3 third-type reference signal resource(s) comprised in the third reference signal resource set is an SSB.

In one embodiment, a radio signal transmitted in the third reference signal resource set and a radio signal transmitted in the first reference signal resource set are QCLed.

In one embodiment, the fourth reference signal resource set comprises K4 fourth-type reference signal resource(s), K4 being a positive integer.

In one subembodiment of the above embodiment, the K4 is equal to 1.

In one subembodiment of the above embodiment, the K4 is greater than 1.

In one subembodiment of the above embodiment, the K4 is equal to the K2, and the K4 fourth-type reference signal resource(s) corresponds(correspond) one-to-one with the K2 second-type reference signal resource(s).

In one subsidiary embodiment of the subembodiment, a given fourth-type reference signal resource is any of the K4 fourth-type reference signal resource(s), the given fourth-type reference signal resource corresponds to a given second-type reference signal resource in the K2 second-type reference signal resource(s), and a radio signal transmitted in the given fourth-type reference signal resource is QCLed with a radio signal transmitted in the given second-type reference signal resource.

In one subembodiment of the above embodiment, there at least exists a radio signal transmitted in a fourth-type reference signal resource among the K4 fourth-type reference signal resource(s) and a radio signal transmitted in a second-type reference signal resource among the K2 second-type reference signal resource(s) being QCLed.

In one subembodiment of the above embodiment, any of the K4 fourth-type reference signal resource(s) comprised in the fourth reference signal resource set is a CSI-RS resource.

In one subembodiment of the above embodiment, any of the K4 fourth-type reference signal resource(s) comprised in the fourth reference signal resource set is an SSB.

In one embodiment, a radio signal transmitted in the fourth reference signal resource set and a radio signal transmitted in the second reference signal resource set are QCLed.

In one embodiment, the channel measurement in the third reference signal resource set is used to generate the pathloss variation value set.

In one embodiment, the channel measurement in the fourth reference signal resource set is used to generate the pathloss variation value set.

In one embodiment, the channel measurement in the third reference signal resource set and the channel measurement in the fourth reference signal resource set are used together to generate the pathloss variation value set.

In one embodiment, the first node determines that the pathloss variation value set satisfies the first condition, and the first node transmits the second information set.

In one embodiment, the pathloss variation value set satisfying the first condition is used to trigger a transmission of the second information set.

Typically, the channel measurement in the third reference signal resource set is used to determine the first pathloss variation value, and the channel measurement in the fourth reference signal resource set is used to determine the second pathloss variation value, the meaning of the pathloss variation value set satisfying the first condition comprises that the first pathloss variation value is greater than a first threshold, or the meaning of the pathloss variation value set satisfying the first condition comprises that the second pathloss variation value is greater than a second threshold, or the meaning of the pathloss variation value set satisfying the first condition comprises that the first pathloss variation value is greater than a third threshold and the second pathloss variation value is greater than a fourth threshold.

In one embodiment, the meaning of the pathloss variation value set satisfying the first condition is that the first pathloss variation value set is greater than a first threshold.

In one embodiment, the meaning of the pathloss variation value set satisfying the first condition is that the second pathloss variation value set is greater than a second threshold.

In one embodiment, the meaning of the pathloss variation value set satisfying the first condition is that the first pathloss variation value set is greater than a third threshold and the second pathloss variation value is greater than a fourth threshold.

In one embodiment, the meaning of the above phrase that the channel measurement in the third reference signal resource set is used to determine the first pathloss variation value comprises: performing measurement respectively in K3 third-type reference signal resource(s) comprised in the third reference signal resource set to obtain K3 pathloss variation value(s), where the first pathloss variation value is a largest one in the K3 pathloss variation value(s).

In one embodiment, the meaning of the above phrase that the channel measurement in the third reference signal resource set is used to determine the first pathloss variation value comprises: performing measurement respectively in K3 third-type reference signal resource(s) comprised in the third reference signal resource set to obtain K3 pathloss variation value(s), where the first pathloss variation value is a smallest one in the K3 pathloss variation value(s).

In one embodiment, the meaning of the above phrase that the channel measurement in the third reference signal resource set is used to determine the first pathloss variation value comprises: performing measurement respectively in K3 third-type reference signal resource(s) comprised in the third reference signal resource set to obtain K3 pathloss variation value(s), where the first pathloss variation value is equal to an average value of the K3 pathloss variation value(s).

In one embodiment, the meaning of the above phrase that the channel measurement in the fourth reference signal resource set is used to determine the second pathloss variation value comprises: performing measurement respectively in K4 fourth-type reference signal resource(s) comprised in the fourth reference signal resource set to obtain K4 pathloss variation value(s), where the second pathloss variation value is a largest one in the K4 pathloss variation value(s).

In one embodiment, the meaning of the above phrase that the channel measurement in the fourth reference signal resource set is used to determine the second pathloss variation value comprises: performing measurement respectively in K4 fourth-type reference signal resource(s) comprised in the fourth reference signal resource set to obtain K4 pathloss variation value(s), where the second pathloss variation value is a smallest one in the K4 pathloss variation value(s).

In one embodiment, the meaning of the above phrase that the channel measurement in the fourth reference signal resource set is used to determine the second pathloss variation value comprises: performing measurement respectively in K4 fourth-type reference signal resource(s) comprised in the fourth reference signal resource set to obtain K4 pathloss variation value(s), where the second pathloss variation value is equal to an average value of K4 pathloss variation value(s).

In one embodiment, the first threshold is measured by dB.

In one embodiment, the second threshold is measured by dB.

In one embodiment, the third threshold is measured by dB.

In one embodiment, the fourth threshold is measured by dB.

In one embodiment, the first threshold and the third threshold are different.

In one embodiment, the first threshold and the third threshold are configured independently.

In one embodiment, the first threshold and the third threshold are configured through an RRC signaling.

In one embodiment, the first threshold is used when the second information set comprises the second power difference value, and the third threshold is used when the second information set comprises the first power difference value.

In a subembodiment, the second threshold and the fourth threshold are different.

In one embodiment, the second threshold and the fourth threshold are configured independently.

In one embodiment, the second threshold and the fourth threshold are configured through an RRC signaling.

In one embodiment, the second threshold is used when the second information set comprises the second power difference value, and the fourth threshold is used when the second information set comprises the first power difference value.

In one embodiment, the first threshold is used when the first node reports a PHR based on an SRS Resource Set.

In one embodiment, the second threshold is used when the first node reports a PHR based on an SRS Resource Set.

In one embodiment, the third threshold and the fourth threshold are used when the first node reports a PHR based on two SRS Resource Sets.

In one embodiment, the first reference signal resource set comprises a first reference signal resource, and the second reference signal resource set comprises a second reference signal resource; a reference signal transmitted in the first reference signal resource and a reference signal transmitted in a third reference signal resource in the third reference signal resource set are QCLed, and a reference signal transmitted in the second reference signal resource and a reference signal transmitted in a fourth reference signal resource in the fourth reference signal resource set are QCLed; a channel measurement in the third reference signal resource is used to determine the first power value, and a channel measurement in the fourth reference signal resource is used to determine the second power value.

In one embodiment, a channel measurement in the third reference signal resource is used to determine the first power value.

In one subembodiment of the embodiment, pathloss determined according to a reference signal transmitted in the third reference signal resource is used to determine the first power value.

In one embodiment, a channel measurement in the fourth reference signal resource is used to determine the second power value.

In one subembodiment of the embodiment, pathloss determined according to a reference signal transmitted in the fourth reference signal resource is used to determine the second power value.

In one embodiment, the QCL refers to Quasi Co-Located.

In one embodiment, the QCL refers to Quasi Co-Location.

In one embodiment, the QCL comprises a QCL parameter.

In one embodiment, the QCL comprises a QCL assumption.

In one embodiment, a type of the QCL comprises QCL-TypeA.

In one embodiment, a type of the QCL comprises QCL-TypeB.

In one embodiment, a type of the QCL comprises QCL-TypeC.

In one embodiment, a type of the QCL comprises QCL-TypeD.

In one embodiment, the QCL-TypeA comprises Doppler shift, Doppler spread, average delay, and delay spread.

In one embodiment, the QCL-TypeB comprises Doppler shift and Doppler spread.

In one embodiment, the QCL-TypeC comprises Doppler shift and average delay.

In one embodiment, the QCL-TypeD comprises Spatial Rx parameter.

In one embodiment, the QCL parameters comprise at least one of delay spread, Doppler spread, Doppler shift, average delay, Spatial Tx parameter or Spatial Rx parameter.

In one embodiment, the Spatial Tx parameter comprises at least one of a transmitting antenna port, a transmitting antenna port group, a transmitting beam, a transmitting analog beamforming matrix, a transmitting analog beamforming vector, a transmitting beamforming matrix, a transmitting beamforming vector or a spatial-domain transmission filter.

In one embodiment, the step S70 is taken after the step S10 and before the step S11 in embodiment 5.

In one embodiment, the step S80 is taken after the step S20 and before the step S21 in embodiment 5.

In one embodiment, the step S71 is taken before step S11 in Embodiment 5.

In one embodiment, the step S70 is taken before step S30 in Embodiment 6.

In one embodiment, the step S80 is taken before step S40 in Embodiment 6.

In one embodiment, the step S70 is taken after step S30 in Embodiment 6.

In one embodiment, the step S80 is taken after step S40 in Embodiment 6.

In one embodiment, the step S70 is taken before step S50 in Embodiment 7.

In one embodiment, the step S80 is taken before step S60 in Embodiment 7.

In one embodiment, the step S70 is taken after step S50 in Embodiment 7.

In one embodiment, the step S80 is taken after step S60 in Embodiment 7.

### Embodiment 9

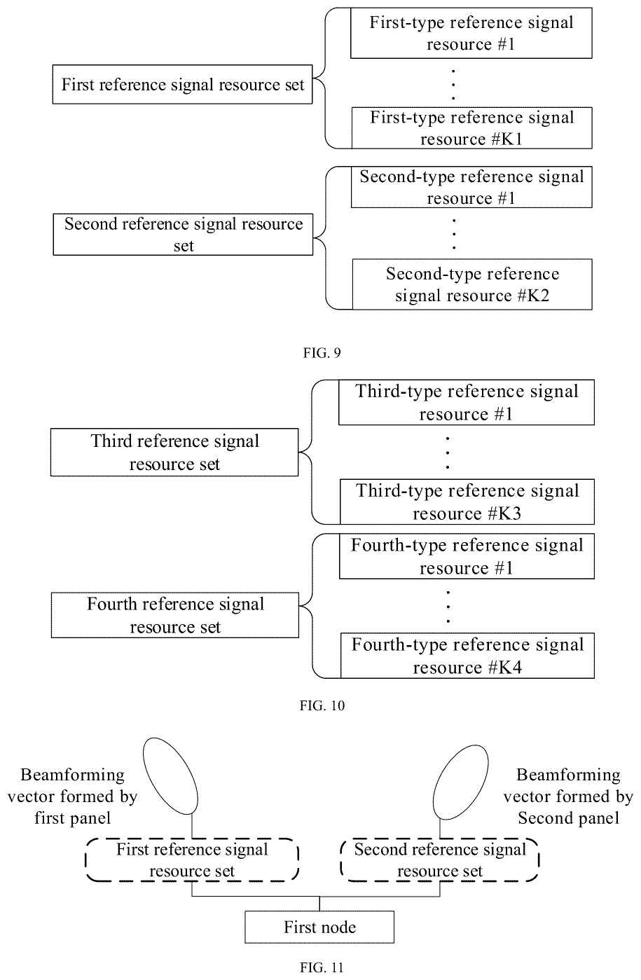

Embodiment 9 illustrates a schematic diagram of a first reference signal resource set and a second reference signal resource set, as shown in FIG. 9. In FIG. 9, the first reference signal resource set comprises K1 first-type reference signal resource(s), respectively corresponding to first-type reference signal resource #1 to first-type reference signal resource #K1 in the figure; the second reference signal resource set comprises K2 second-type reference signal resource(s), respectively corresponding to second-type reference signal resource #1 to second-type reference signal resource #K2; K1 is a positive integer, and the K2 is a positive integer.

In one embodiment, K1 is equal to 1, and the first reference signal resource set only comprises the first reference signal resource in the present application.

In one embodiment, K2 is equal to 1, and the second reference signal resource set only comprises the second reference signal resource in the present application.

In one embodiment, K1 is greater than 1.

In one embodiment, K2 is greater than 1.

In one embodiment, the first target power value is applicable to all reference signal resources in the first reference signal resource set.

In one embodiment, the first target power value is applicable to a first reference signal resource in the first reference signal resource set.

In one embodiment, the first target power value is applicable to all reference signal resources in the second reference signal resource set.

In one embodiment, the first target power value is applicable to a second reference signal resource in the second reference signal resource set.

In one embodiment, the second target power value is applicable to all reference signal resources in the first reference signal resource set.

In one embodiment, the second target power value is applicable to a first reference signal resource in the first reference signal resource set.

In one embodiment, the second target power value is applicable to all reference signal resources in the second reference signal resource set.

In one embodiment, the second target power value is applicable to a second reference signal resource in the second reference signal resource set.

In one embodiment, the first target power value is adopted when the second information set only comprises the first power difference value.

In one embodiment, the second target power value is adopted when the second information set comprises the first power difference value and the second power difference value at the same time.

In one embodiment, the first reference signal resource set and the second reference signal resource set respectively correspond to two different Panel IDs.

In one embodiment, the first reference signal resource set and the second reference signal resource set respectively correspond to two panels comprised in the first node.

In one embodiment, the first reference signal resource set and the second reference signal resource set respectively correspond to two Radio Frequency (RF) comprised in the first node.

In one embodiment, the first reference signal resource set and the second reference signal resource set respectively correspond to two radio frequency channels comprised in the first node.

### Embodiment 10

Embodiment 10 illustrates a schematic diagram of a third reference signal resource set and a fourth reference signal resource set, as shown in FIG. 10. In FIG. 10, the third reference signal resource set comprises K3 third-type reference signal resource(s), respectively corresponding to third-type reference signal resource #1 to third-type reference signal resource #K3 in the figure; the fourth reference signal resource set comprises K4 fourth-type reference signal resource(s), respectively corresponding to fourth-type reference signal resource #1 to fourth-type reference signal resource #K4 in the figure; K3 is a positive integer, and the K4 is a positive integer.

In one embodiment, K3 is equal to 1, and the third reference signal resource set only comprises the third reference signal resource in the present application.

In one embodiment, K4 is equal to 1, and the fourth reference signal resource set only comprises the fourth reference signal resource in the present application.

In one embodiment, the K3 is greater than 1.

In one embodiment, the K4 is greater than 1.

In one embodiment, the first target power value is applicable to all reference signal resources in the third reference signal resource set.

In one embodiment, the first target power value is applicable to a third reference signal resource in the third reference signal resource set.

In one embodiment, the first target power value is applicable to all reference signal resources in the fourth reference signal resource set.

In one embodiment, the first target power value is applicable to a fourth reference signal resource in the fourth reference signal resource set.

In one embodiment, the second target power value is applicable to all reference signal resources in the third reference signal resource set.

In one embodiment, the second target power value is applicable to a third reference signal resource in the third reference signal resource set.

In one embodiment, the second target power value is applicable to all reference signal resources in the fourth reference signal resource set.

In one embodiment, the second target power value is applicable to a fourth reference signal resource in the fourth reference signal resource set.

In one embodiment, the third reference signal resource set and the fourth reference signal resource set respectively correspond to two different IDs.

In one embodiment, the third reference signal resource set and the fourth reference signal resource set respectively correspond to two different PCIs.

In one embodiment, the third reference signal resource set and the fourth reference signal resource set respectively correspond to the two TRPs comprised in the second node.

In one embodiment, the third reference signal resource set and the fourth reference signal resource set respectively correspond to the two RF channels comprised in the second node.

### Embodiment 11

Embodiment 11 illustrates a schematic diagram of a first node, as shown in FIG. 11. In FIG. 11, the first node has two panels, namely a first panel and a second panel, which are respectively associated with a first reference signal resource set and a second reference signal resource set; the two panels can transmit two independent radio signals in a same time-frequency resource.

In one embodiment, a maximum transmit power value can be dynamically shared between the first panel and the second panel.

In one embodiment, when the first panel and the second panel are used simultaneously, a sum of a maximum transmit power value of the first panel and a maximum transmit power value of the second panel is not greater than a first power threshold.

In one embodiment, the first target power value in the present application is not greater than the first power threshold.

In one embodiment, when the first panel or second panel is used separately, a maximum transmit power value of the first panel or the second panel is a second power threshold.

In one embodiment, the second target power value in the present application is not greater than the second power threshold.

### Embodiment 12

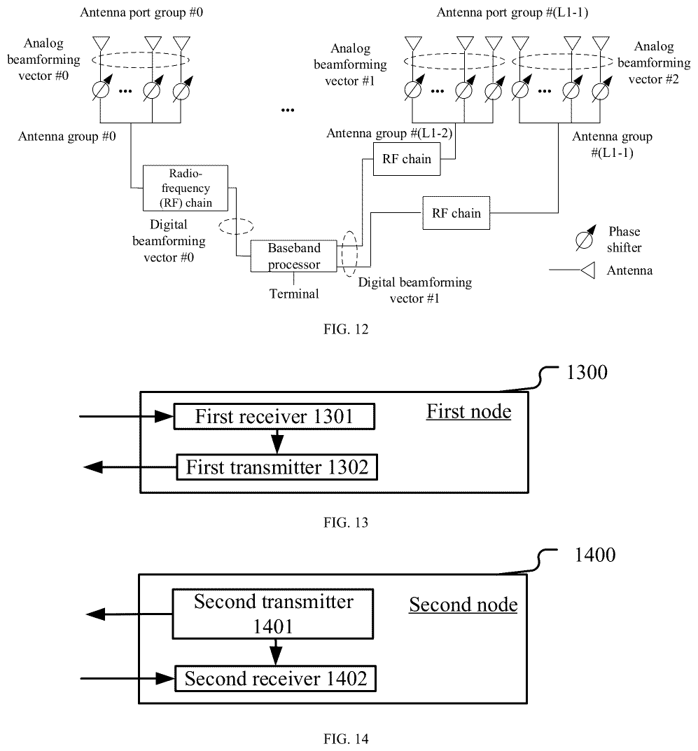

Embodiment 12 illustrates a schematic diagram of antenna ports and antenna port groups, as shown in FIG. 12.

In Embodiment 12, one antenna port group comprises a positive integer number of antenna port(s); one antenna port is formed by superposition of antennas in a positive integer number of antenna group(s) through antenna virtualization; one antenna group comprises a positive integer number of antenna(s). An antenna group is connected to the baseband processor through a Radio Frequency (RF) chain, and different antenna groups correspond to different RF chains. Mapping coefficients from all antennas in a positive integer number of antenna group(s) comprised in a given antenna port to the given antenna port constitute a beamforming vector corresponding to the given antenna port. Mapping coefficients from multiple antennas comprised in any given antenna group within a positive integer number of antenna group(s) comprised in the given antenna port to the given antenna port constitute an analog beamforming vector of the given antenna group. Analog beamforming vectors corresponding to the positive integer number of antenna group(s) are arranged diagonally to form an analog beamforming matrix corresponding to the given antenna port. Mapping coefficients from the positive integer number of antenna group(s) to the given antenna port constitute a digital beamforming vector corresponding to the given antenna port. A beamforming vector corresponding to the given antenna port is acquired as a product of the analog beamforming matrix and the digital beamforming vector corresponding to the given antenna port. Different antenna ports in an antenna port group consist of a same antenna group, and different antenna ports in a same antenna port group correspond to different beamforming vectors.

FIG. 12 illustrates two antenna port groups, namely, antenna port group #0 and antenna port group #1. Herein, the antenna port group #0 consists of antenna group #0, and the antenna port group #1 consists of antenna group #1 and antenna group #2. Mapping coefficients from multiple antennas of the antenna group #0 to the antenna port group #0 constitute analog beamforming vector #0; and mapping coefficients from the antenna group #0 to the antenna port group #0 constitute a digital beamforming vector #0; mapping coefficients from multiple antennas in the antenna group #1 and multiple antennas in the antenna group #2 to the antenna port group #1 respectively constitute analog beamforming vector #1 and analog beamforming vector #2; and mapping coefficients from the antenna group #1 and the antenna group #2 to the antenna port group #1 constitute a digital beamforming vector #1. A beamforming vector corresponding to any antenna port in the antenna port group #0 is acquired as a product of the analog beamforming vector #0 and the digital beamforming vector #0. A beamforming vector corresponding to any antenna port in the antenna port group #1 is acquired as a product of an analog beamforming matrix formed by the analog beamforming vector #1 and the analog beamforming vector #2 arranged diagonally and the digital beamforming vector #1.

In one subembodiment, an antenna port group comprises an antenna port. For example, the antenna port group #0 in FIG. 12 comprises an antenna port.

In one subsidiary embodiment of the above subembodiment, an analog beamforming matrix corresponding to the antenna port is subjected to dimensionality reduction to form an analog beamforming vector, a digital beamforming vector corresponding to the antenna port is subjected to dimensionality reduction to form a scaler, and a beamforming vector corresponding to the antenna port is equal to an analog beamforming vector corresponding to the antenna port.

In one subembodiment, an antenna port group comprises multiple antenna ports. For example, the antenna port group #1 in FIG. 12 comprises multiple antenna ports.

In one subsidiary embodiment of the above subembodiment, the multiple antenna ports correspond to a same analog beamforming matrix and different digital beamforming vectors.

In one subembodiment, antenna ports in different antenna port groups correspond to different analog beamforming matrices.

In one subembodiment, any two antenna ports in an antenna port group are QCLed (Quasi-Colocated).

In one subembodiment, any two antenna ports of an antenna port group are spatially QCLed.

In one embodiment, multiple antenna port groups in the figure correspond to one panel in the present application.

In one embodiment, the first reference signal resource set corresponds to multiple antenna port groups.

In one embodiment, the second reference signal resource set corresponds to multiple antenna port groups.

In one embodiment, one reference signal resource in the first reference signal resource set corresponds to an antenna port group.

In one embodiment, one reference signal resource in the second reference signal resource set corresponds to an antenna port group.

### Embodiment 13

Embodiment 13 illustrates a structure block diagram in a first node, as shown in FIG. 13. In FIG. 13, a first node 1300 comprises a first receiver 1301 and a first transmitter 1302.

A first receiver 1301 receives a first information set, the first information set is used to indicate a first reference signal resource set and a second reference signal resource set;
a first transmitter 1302 transmits a target signal, the target signal comprises a second information set;

In embodiment 13, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the second information set comprises a second power difference value, and the second power difference value is equal to a difference value of a second target power value minus a second reference power value; the second reference power value is associated with a first reference signal resource set, or the second reference power value is associated with the second reference signal resource set.

In one embodiment, the target signal comprises two sub-signals that are respectively associated with the first reference signal resource set and the second reference signal resource set and are overlapping in time-frequency domain, and the second information set comprises the first power difference value and the second power difference value at the same time.

In one embodiment, it is characterized in comprising:
the first transmitter 1302 transmits a first signal in a first time window;
herein, the target signal comprises two sub-signals that are respectively associated with the first reference signal resource set and the second reference signal resource set and are overlapping in time-frequency domain; a transmit power value of the first signal is the first reference power value.

In one embodiment, it is characterized in comprising:
the first transmitter 1302 transmits a second signal in a second time window;
herein, the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

In one embodiment, it is characterized in comprising:
the first receiver 1301 performs a channel measurement in a third reference signal resource set and a channel measurement in a fourth reference signal resource set; and determines that a pathloss variation value set satisfies a first condition;
herein, the third reference signal resource set is associated with the first reference signal resource set, and the fourth reference signal resource set is associated with the second reference signal resource set; at least one of the channel measurement in the third reference signal resource set or the channel measurement in the fourth reference signal resource set is used to generate the pathloss variation value set.

In one embodiment, the channel measurement in the third reference signal resource set is used to determine the first pathloss variation value, and the channel measurement in the fourth reference signal resource set is used to determine the second pathloss variation value, the meaning of the pathloss variation value set satisfying the first condition comprises that the first pathloss variation value is greater than a first threshold, or the meaning of the pathloss variation value set satisfying the first condition comprises that the second pathloss variation value is greater than a second threshold, or the meaning of the pathloss variation value set satisfying the first condition comprises that the first pathloss variation value is greater than a third threshold and the second pathloss variation value is greater than a fourth threshold.

In one embodiment, the first receiver 1301 comprises at least first four of the antenna 452, the receiver 454, the multi-antenna receiving processor 458, the receiving processor 456 and the controller/processor 459 in embodiment 4.

In one embodiment, the first transmitter 1302 comprises at least the first four of the antenna 452, the transmitter 454, the multi-antenna transmitting processor 457, the transmitting processor 468 and the controller/processor 459 in embodiment 4.

In one embodiment, the first information set is transmitted through an RRC signaling; the first reference signal resource set and the second reference signal resource set are two different SRS resource sets, respectively; the second information set is PHR, and the first power difference is PH; the second power value and the third power value are both transmit power values of PUSCH; the target signal is PUSCH.

### Embodiment 14

Embodiment 14 illustrates a structure block diagram in a second node, as shown in FIG. 14. In FIG. 14, a second node 1400 comprises a second transmitter 1401 and a second receiver 1402.

A second transmitter 1401 transmits a first information set, the first information set is used to indicate a first reference signal resource set and a second reference signal resource set;
a second receiver 1402 receives a target signal, and the target signal comprises a second information set;

In embodiment 14, the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

In one embodiment, the second information set comprises a second power difference value, and the second power difference value is equal to a difference value of a second target power value minus a second reference power value; the second reference power value is associated with a first reference signal resource set, or the second reference power value is associated with the second reference signal resource set.

In one embodiment, the target signal comprises two sub-signals that are respectively associated with the first reference signal resource set and the second reference signal resource set and are overlapping in time-frequency domain, and the second information set comprises the first power difference value and the second power difference value at the same time.

In one embodiment, it is characterized in comprising:
the second receiver 1402 receives a first signal in a first time window;
herein, the target signal comprises two sub-signals that are respectively associated with the first reference signal resource set and the second reference signal resource set and are overlapping in time-frequency domain; a transmit power value of the first signal is the first reference power value.

In one embodiment, it is characterized in comprising:
the second receiver 1402 receives a second signal in a second time window;
herein, the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

In one embodiment, it is characterized in comprising:
the second transmitter 1401 transmits a reference signal in a third reference signal resource set and transmits a reference signal in a fourth reference signal resource set;
herein, the third reference signal resource set is associated with the first reference signal resource set, and the fourth reference signal resource set is associated with the second reference signal resource set; at least one of the channel measurement in the third reference signal resource set or the channel measurement in the fourth reference signal resource set is used by a transmitter of the target signal to generate the pathloss variation value set, and the pathloss variation value set satisfies a first condition.

In one embodiment, the channel measurement in the third reference signal resource set is used to determine the first pathloss variation value, and the channel measurement in the fourth reference signal resource set is used to determine the second pathloss variation value, the meaning of the pathloss variation value set satisfying the first condition comprises that the first pathloss variation value is greater than a first threshold, or the meaning of the pathloss variation value set satisfying the first condition comprises that the second pathloss variation value is greater than a second threshold, or the meaning of the pathloss variation value set satisfying the first condition comprises that the first pathloss variation value is greater than a third threshold and the second pathloss variation value is greater than a fourth threshold.

In one embodiment, the second transmitter 1401 comprises at least first four of the antenna 420, the transmitter 418, the multi-antenna transmitting processor 471, the transmitting processor 414 and the controller/processor 475 in embodiment 4.

In one embodiment, the second receiver 1402 comprises at least the first four of the antenna 420, the receiver 418, the multi-antenna receiving processor 472, the receiving processor 470 and the controller/processor 475 in embodiment 4.

In one embodiment, the first information set is transmitted through an RRC signaling; the first reference signal resource set and the second reference signal resource set are two different SRS resource sets, respectively; the second information set is PHR, and the first power difference is PH; the second power value and the third power value are both PUSCH transmit power values; the target signal is PUSCH.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, cars, RSUs (Road Side Unit), aircrafts, diminutive airplanes, unmanned aerial vehicles, tele-controlled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS (Global Navigation Satellite System), relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information set, the first information set being used to indicate a first reference signal resource set and a second reference signal resource set; and
a first transmitter, transmitting a target signal, the target signal comprising a second information set;
wherein the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

2. The first node according to claim 1, wherein the second information set comprises a second power difference value, and the second power difference value is equal to a difference value of a second target power value minus a second reference power value; the second reference power value is associated with a first reference signal resource set, or the second reference power value is associated with the second reference signal resource set.

3. The first node according to claim 2, wherein the target signal comprises two sub-signals that are respectively associated with the first reference signal resource set and the second reference signal resource set and are overlapping in time-frequency domain, and the second information set comprises the first power difference value and the second power difference value at the same time.

4. The first node according to claim 1, comprising:
the first transmitter, transmitting a first signal in a first time window;
wherein the target signal comprises two sub-signals that are respectively associated with the first reference signal resource set and the second reference signal resource set and are overlapping in time-frequency domain; a transmit power value of the first signal is the first reference power value.

5. The first node according to claim 2, comprising:
the first transmitter, transmitting a second signal in a second time window;
wherein the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

6. The first node according to claim 1, comprising:
the first receiver, performing a channel measurement in a third reference signal resource set and a channel measurement in a fourth reference signal resource set; and determining that a pathloss variation value set satisfies a first condition;
wherein the third reference signal resource set is associated with the first reference signal resource set, and the fourth reference signal resource set is associated with the second reference signal resource set; at least one of the channel measurement in the third reference signal resource set or the channel measurement in the fourth reference signal resource set is used to generate the pathloss variation value set.

7. The first node according to claim 6, wherein the channel measurement in the third reference signal resource set is used to determine the first pathloss variation value, and the channel measurement in the fourth reference signal resource set is used to determine the second pathloss variation value, the meaning of the pathloss variation value set satisfying the first condition comprises that the first pathloss variation value is greater than a first threshold, or the meaning of the pathloss variation value set satisfying the first condition comprises that the second pathloss variation value is greater than a second threshold, or the meaning of the pathloss variation value set satisfying the first condition comprises that the first pathloss variation value is greater than a third threshold and the second pathloss variation value is greater than a fourth threshold.

8. The first node according to claim 1, wherein a number of power difference value(s) comprised in the second information set is related to whether the target signal comprises two sub-signals that are respectively associated with the first reference signal resource set and the second reference signal resource set and are overlapping in time-frequency domain.

9. The first node according to claim 8, wherein the target signal comprises two sub-signals that are respectively associated with the first reference signal resource set and the second reference signal resource set and are overlapping in time-frequency domain, and the second information set comprises two power difference values; the two power difference values comprised in the second information set are respectively the first power difference value and the second power difference value.

10. The first node according to claim 8, wherein the target signal only comprises a sub-signal associated with either the first reference signal resource set or the second reference signal resource set, and the second information set only comprises a power difference value; the power difference value comprised in the second information set is the second power difference value.

11. The first node according to claim 1, wherein the first power value and the second power value are respectively transmit power values adopted by the first node to transmit a radio signal generated by a TB on a spatial Tx parameter corresponding to a reference signal resource in the first reference signal resource set and to transmit a radio signal generated by a TB on a spatial Tx parameter corresponding to a reference signal resource in the second reference signal resource set at the same time.

12. The first node according to claim 1, wherein the first power value and the second power value are power values respectively adopted by the first node to transmit two radio sub-signals at the same time on a spatial Tx parameter corresponding to a reference signal resource in the first reference signal resource set and on a spatial Tx parameter corresponding to a reference signal resource in the second reference signal resource set.

13. The first node according to claim 1, wherein the first target power value is a maximum transmit power value that can be adopted by the first node to transmit radio signals on two panels at the same time.

14. The first node according to claim 2, wherein the second target power value is a maximum transmit power value that can be adopted by the first node to transmit a radio signal on a panel at the same time.

15. A second node for wireless communications, comprising:
a second transmitter, transmitting a first information set, the first information set being used to indicate a first reference signal resource set and a second reference signal resource set; and
a second receiver, receiving a target signal, the target signal comprising a second information set;
wherein the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.

16. The second node according to claim 15, wherein the second information set comprises a second power difference value, and the second power difference value is equal to a difference value of a second target power value minus a second reference power value; the second reference power value is associated with a first reference signal resource set, or the second reference power value is associated with the second reference signal resource set.

17. The second node according to claim 16, wherein the target signal comprises two sub-signals that are respectively associated with the first reference signal resource set and the second reference signal resource set and are overlapping in time-frequency domain, and the second information set comprises the first power difference value and the second power difference value at the same time.

18. The second node according to claim 15, comprising:
the second receiver, receiving a first signal in a first time window;
wherein the target signal comprises two sub-signals that are respectively associated with the first reference signal resource set and the second reference signal resource set and are overlapping in time-frequency domain; a transmit power value of the first signal is the first reference power value.

19. The second node according to claim 16, comprising:
the second receiver, receiving a second signal in a second time window;
wherein the second signal is associated with either the first reference signal resource set or the second reference signal resource set, a transmit power value of the second signal is the second reference power value, and the second signal and the second reference power value are associated with a same reference signal resource set in the first reference signal resource set and the second reference signal resource set.

20. A method in a first node for wireless communications, comprising:
receiving a first information set, the first information set being used to indicate a first reference signal resource set and a second reference signal resource set; and
transmitting a target signal, the target signal comprising a second information set;
wherein the second information set comprises a first power difference value; the first power difference value is equal to a difference value of a first target power value minus a first reference power value, and the first reference power value is equal to a sum of a first power value and a second power value; the first power value is associated with the first reference signal resource set, and the second power value is associated with the second reference signal resource set.
